(19) United States
(12) Patent Application Publication
(10) Pub. No.: US 2025/0180444 A1
(43) Pub. Date: Jun. 5, 2025

(54) LASER MICRODISSECTION SYSTEM AND METHOD FOR LASER MICRODISSECTION

(71) Applicant: Leica Microsystems CMS GmbH, Wetzlar (DE)

(72) Inventors: Christoph GREB, Wetzlar (DE); James MARR, Wetzlar (DE)

(21) Appl. No.: 18/957,910

(22) Filed: Nov. 25, 2024

(30) Foreign Application Priority Data
Nov. 30, 2023 (DE) 102023133508.1

(51) Int. Cl. G01N 1/28; G06T 7/00

(52) U.S. Cl. CPC G01N 1/286; G06T 7/0014; G01N 2001/2886; G06T 2207/10028; G06T 2207/10064; G06T 2207/20081; G06T 2207/30024

(57) ABSTRACT

A laser microdissection system includes a microscope stage configured to receive a sample to be cut and a collecting unit comprising a collecting vessel arranged below the sample, an optical detection unit configured to capture a content image of an interior of the collecting vessel and to generate content image data corresponding to the content image, and a control unit configured to process the content image data and to determine whether a dissectate cut from the sample is located in the collecting vessel based on the content image data and taking into account previous image data corresponding to a previous image of the interior of the collecting vessel that was taken before the dissectate was cut from the sample, and/or taking into account reference image data corresponding to a reference image of an interior of a reference collecting vessel of a same type as the at least one collecting vessel.

### CROSS REFERENCE TO RELATED APPLICATIONS

This application claims benefit to German Patent Application No. DE 102023133508.1, filed on Nov. 30, 2023, which is hereby incorporated by reference herein.

### FIELD

Embodiments of the present invention relate to a laser microdissection system and a method for laser microdissection.

### BACKGROUND

In laser microdissection, a sample is cut with a laser to remove a small part of the sample, called a dissectate. Laser microdissection systems are known from the prior art, which use gravity to collect the dissectate cut out of the sample in a collecting vessel arranged below the sample—for example, a PCR tube or a well of a multiwell plate. Finding the dissectate in the collecting vessel can sometimes be very time-consuming, since the dissectate is very small compared to the area to be searched. In addition, the dissectate can be located not only on the bottom of the collecting vessel, but also on a wall of the collecting vessel, so that not only a surface, but, rather, a volume needs to be searched for the dissectate. The loss of time is noticeable, negatively, in particular in high-throughput experiments where, for example, multiwell plates with 96 or 384 wells are used.

### SUMMARY

Embodiments of the present invention provide a laser microdissection system. The laser microdissection system includes a microscope stage configured to receive a sample to be cut and a collecting unit comprising at least one collecting vessel arranged below the sample. The at least one collecting vessel is arranged and configured to collect a dissectate cut out of the sample. The laser microdissection system further includes an optical detection unit configured to capture a content image of an interior of the at least one collecting vessel and to generate content image data corresponding to the content image, and a control unit configured to process the content image data and to determine whether the dissectate is located in the at least one collecting vessel based on the content image data and taking into account previous image data corresponding to a previous image of the interior of the at least one collecting vessel that was taken before the dissectate was cut from the sample, and/or taking into account reference image data corresponding to a reference image of an interior of a reference collecting vessel of a same type as the at least one collecting vessel.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a laser microdissection system according to an exemplary embodiment;

FIG. 2 is a flowchart of a laser microdissection method according to some embodiments; and

FIG. 3 is a schematic illustration of a sample carrier on which a sample is arranged according to some embodiments.

### DETAILED DESCRIPTION

Embodiments of the invention provide a laser microdissection system and a method for laser microdissection which make it possible to quickly and easily determine whether a dissectate has been collected in a collecting vessel.

The laser microdissection system comprises a microscope stage designed to accommodate a sample to be cut and a collecting unit comprising at least one collecting vessel arranged below the sample. The at least one collecting vessel is arranged and designed to collect a dissectate cut from the sample. The laser microdissection system further comprises an optical detection unit, configured to capture a content image of an interior of the at least one collecting vessel and to generate content image data corresponding to the content image, and a control unit. The control unit is designed to process the content image data and to determine whether the dissectate is located in the at least one collecting vessel based upon the content image data and taking into account before image data corresponding to a before image of the interior of the at least one collecting vessel that was taken before the dissectate was cut from the sample and/or taking into account reference image data corresponding to a reference image of an interior of a collecting vessel of the same type as the at least one collecting vessel.

The laser microdissection system has a laser light source and is designed to use the laser beam generated by the laser light source to cut out a small part of the sample, the dissectate. The dissectate then falls, under the influence of gravity, into at least one collecting vessel. In order to now be able to find out whether the dissectate was correctly collected in the at least one collecting vessel, the at least one collecting vessel is inspected. In the prior art, the inspection of collecting vessels is done manually and visually, i.e., the collecting vessels are manually adjusted in height and/or laterally, and visually searched for the dissectate. In the proposed laser microdissection system, this process is automated. Thus, the proposed laser microdissection system enables quick and easy determination of whether the dissectate has been collected in the at least one collecting vessel. This saves a lot of time, especially in high-throughput experiments.

In order to inspect at least one collecting vessel, the laser microdissection system captures the content image after the dissectate has been cut from the sample. The laser microdissection system then determines, based upon the content image, whether the dissectate is located in the at least one collecting vessel, i.e., whether the dissectate was collected correctly.

Another basis for this determination is, for example, the before image, i.e., an image of the interior of at least one collecting vessel which was taken directly before the dissectate was cut from the sample. For example, the laser microdissection system can determine whether the dissectate was captured correctly by comparing the content image with the before image. Furthermore, the reference image can serve as the basis or a further basis for the determination. The reference image is an image of the interior of a collecting vessel of the same type as the at least one collecting vessel. For example, if the at least one collecting vessel is a cap of a PCR tube, then the reference image is an image of a cap of another PCR tube with the same dimensions as the at least one collecting vessel.

The sample to be cut can be a tissue section or a similarly thin biological preparation and is attached to a sample carrier—for example, by a membrane. The collecting vessel can in particular be a PCR tube, a cap of a PCR tube, or a well of a multiwell plate. However, other common laboratory materials such as a Petri dish can also be used as the collecting vessel.

In a further embodiment, the control unit is designed to determine a position of the dissectate in the interior of the at least one collecting vessel on the basis of the content image data. The position of the dissectate can, for example, be used to capture a verification image that can be used to check that the dissectate is actually located inside the at least one collecting vessel. It can thus be ensured that the control unit has correctly determined that the dissectate is located in the at least one collecting vessel. This information can also be used to improve the processing of the content image data by the control unit in order to enable more reliable determination. The position of the dissectate can also be used to capture a detailed image of the dissectate at a high magnification.

In a further embodiment, the control unit is designed to compare the content image data with the before image data and/or the reference image data and to determine on the basis of this comparison whether the dissectate is located in the at least one collecting vessel. In this embodiment, the control unit performs, for example, an image comparison between the content image and the before image and/or the reference image, in order to determine whether the dissectate was correctly collected in the at least one collecting vessel. Such an image comparison can be carried out in particular using known image comparison algorithms. By comparing images, the control unit can quickly and particularly easily determine whether the dissectate is located in the at least one collecting vessel.

In a further embodiment, the control unit is designed to determine, using a machine learning method, whether the dissectate is located in the at least one collecting vessel. As the machine learning method, the control unit can use, for example, one or more neural networks, e.g., a convolutional neural network, an autoencoder, or a generative adversarial network. Furthermore, the control unit can also use other methods, such as decision trees, random forests, or a K-Nearest Neighbors method, as the machine learning method. Machine learning methods can identify features in images with high precision. They are often able to recognize patterns and details that are difficult for the human eye to distinguish. This makes machine learning methods particularly suitable for recognizing the dissectate in the content image. By using the machine learning method, the control unit can thus determine particularly reliably whether the dissectate is located in the at least one collecting vessel.

In a further embodiment, the machine learning method has been trained, using at least the reference image data as training data, to determine whether the dissectate is located in the at least one collecting vessel. For example, the machine learning method was trained to recognize the dissectate in the content image and to distinguish it for example from scratches, dirt, or other objects inside the collecting vessel. In particular, the machine learning method has been trained to compare the content image data with the before image data and/or the reference image data and to determine, on the basis of this comparison, whether the dissectate is located in the at least one collecting vessel.

In a further embodiment, the machine learning method has been trained to perform image segmentation of the content image in order to determine whether the dissectate is located in the at least one collecting vessel. In the image segmentation, the content image is divided into regions. Each region corresponds to a different part of the content image—for example, the dissectate, the bottom or the wall of the at least one collecting vessel, a scratch, or contamination. Based upon the image segmentation, it can be determined particularly reliably whether the dissectate is located in the at least one collecting vessel.

In a further embodiment, the control unit is designed to control at least the optical detection unit in order to capture the content image as a volume image and/or an image with extended depth of field. For example, the control unit can be designed to control a lens of the detection unit directed at the collecting vessel, in order to shift the focus position of the detection unit along the optical axis. In this way, the detection unit can detect a plurality of parallel planes within the collecting vessel, in order to capture the content image as a volume image and/or an image with extended depth of field. In order to obtain an image with extended depth of field (also called an extended depth of field, or edof, image), images with different focus positions are typically combined into a single image that has a high depth of field. Compared to a volume image, this has the advantage that an image with extended depth of field requires less storage space. In this embodiment, the laser microdissection system generates the content image such that the entire interior of the at least one collecting vessel is sharply imaged. This makes it possible to determine very reliably whether the dissectate is located in the at least one collecting vessel, even if the dissectate is located, for example, on a wall of the at least one collecting vessel.

In a further embodiment, the microscope stage can be moved in a motorized manner along an optical axis of the optical detection unit. The control unit can be designed to move the microscope stage along the optical axis of the optical detection unit in order to capture the content image as a volume image and/or an image with extended depth of field. For example, the microscope stage can be moved very precisely using a piezo motor. In this embodiment, instead of the focus position of the optical detection unit, the collecting unit and/or the at least one collecting vessel are moved along the optical axis of the optical detection unit in order to detect a plurality of parallel planes within the collecting vessel. This also makes it possible, with the aforementioned advantages, to capture the content image as a volume image and/or an image with extended depth of field.

In a further embodiment, the control unit is designed to determine, taking into account a size of the dissectate, whether the dissectate is located in the at least one collecting vessel. The size of the dissectate can, for example, be a length, a width, a diameter, or the surface area of the dissectate and can be determined, for example, automatically based upon the region of the sample from which the dissectate was cut out. This region is also called region of interest, or ROI. Taking into account the size of the dissectate, this can be found much more reliably in the content image and distinguished from, for example, scratches or contamination of the at least one collecting vessel.

In another embodiment, the laser microdissection system comprises a user input unit which is configured to receive a user input. The control unit can be designed to determine the size of the dissectate based upon a corresponding user input. In this embodiment, a user defines, e.g., through user input, the dimensions of the region of the sample from which the dissectate is to be cut out. From this information, the control unit can then determine the size of the dissectate. Alternatively or additionally, the user can also enter the size of the dissectate directly. Taking into account the size of the dissectate when determining whether the dissectate is in the at least one collecting vessel has the advantages mentioned above.

In a further embodiment, the control unit is configured to determine the size of the dissectate based upon sample image data corresponding to an image of the sample acquired before or after the dissectate was cut from the sample. In this embodiment, the size of the dissectate is determined fully automatically by the laser microdissection system. For example, the control unit can use an image acquired after the dissectate has been cut from the sample to determine the size of the region of the sample from which the dissectate was cut. The size of this region is identical to the size of the dissectate. In another example, the controller may be configured to determine a region from which the dissectate is to be cut out, based upon the sample image data corresponding to an image of the sample acquired before the dissectate was cut out of the sample. For this purpose, the user can in particular determine certain structures of the sample, which are automatically identified by the control unit in the image of the sample—for example, certain cells. The size of this region is also identical to the size of the dissectate. Taking into account the size of the dissectate when determining whether the dissectate is in the at least one collecting vessel has the advantages mentioned above.

In a further embodiment, the laser microdissection system comprises an illumination unit configured to emit excitation light for exciting fluorophores. The optical detection unit is designed to capture fluorescence images. In this embodiment, the illumination unit is designed to excite fluorophores arranged, for example, in the sample—and thus also in the dissectate—to emit fluorescent light. For example, the illumination unit comprises one or more laser light sources for generating the excitation light. The fluorophores can in particular be dyes that have been intentionally introduced into the sample and by means of which certain structures of the sample, such as cell nuclei, have been stained. This makes it particularly easy to identify the stained structures in a fluorescence image of the dissectate.

In a further embodiment, the control unit is configured to control the illumination unit and the optical detection unit in order to capture the content image as a fluorescence image. Based upon the fluorescent light emitted by the dissectate, the dissectate can be particularly easily found in the content image. This makes the determination of whether the dissectate is located in the at least one collecting vessel particularly reliable. The fluorescence detected in the fluorescence image may in particular be actually disturbing autofluorescence—for example, of a thin polymer membrane on which the sample and thus also the dissectate are arranged. Thus, in this embodiment, an actually disturbing effect can be used to reliably determine whether the dissectate is located in the at least one collecting vessel.

In a further embodiment, the control unit is designed to control the illumination unit and the optical detection unit in order to capture a verification image as a fluorescence image when the control unit has determined that the dissectate is located in the at least one collecting vessel, to generate verification image data corresponding to the verification image, and to confirm on the basis of the verification image data that the dissectate is located in the at least one collecting vessel. In this embodiment, the laser microdissection system first captures the content image, in particular as a white light image, and determines on the basis of the content image whether the dissectate is located in the at least one collecting vessel. In order to confirm that this determination was correct, the laser microdissection system subsequently captures the verification image as a fluorescence image. Preferably, the control unit first determines the position of the dissectate in the at least one collecting vessel on the basis of the content image data. The laser microdissection system can then capture the verification image at the determined position. With the help of the verification image, it is possible to check that the dissectate is located in the at least one collecting vessel, as determined. In this way, ambiguities can be resolved if, for example, scratches or contamination of the at least one collecting vessel have been wrongly identified as the dissectate. It is furthermore ensured that the control unit is working correctly.

Embodiments of the invention also relate to a method for laser microdissection. In the method, a sample is placed above at least one collecting vessel of a collecting unit. In this case, the at least one collecting vessel is arranged and designed to collect a dissectate cut from the sample. A content image of an interior of the at least one collecting vessel is captured, and content image data corresponding to the content image are generated. Based upon the content image data and taking into account before image data corresponding to a before image of the interior of the at least one collecting vessel that was taken before the dissectate was cut from the sample, and/or taking into account reference image data corresponding to a reference image of an interior of a collecting vessel of the same type as the at least one collecting vessel, it is determined whether the dissectate is located in the at least one collecting vessel.

The method has the same advantages as the claimed laser microdissection system. In particular, the method can be further developed using the features of the dependent claims directed at the laser microdissection system. Furthermore, the above-described laser microdissection system can be further developed using the features described in this document in connection with the method.

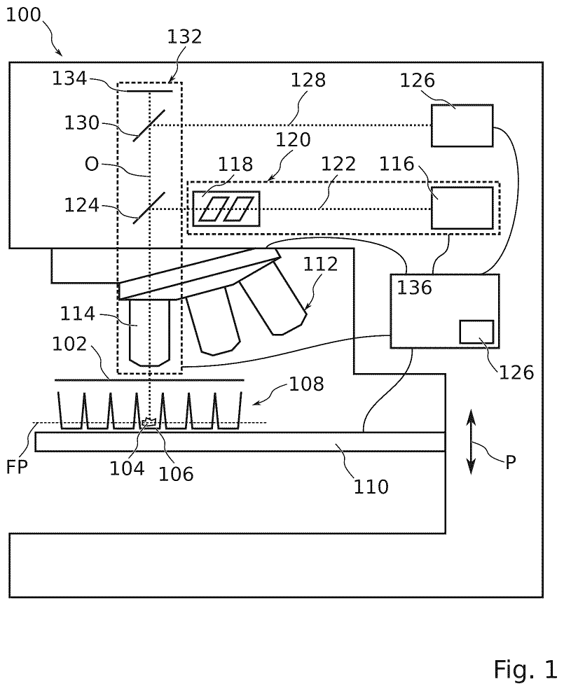

FIG. 1 is a schematic illustration of a laser microdissection system 100 according to an exemplary embodiment.

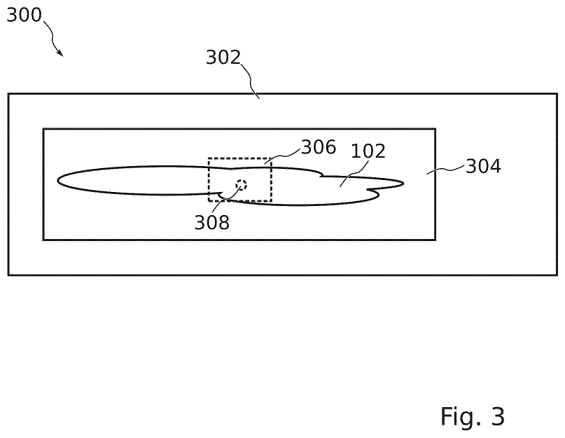

The laser microdissection system 100 is designed to cut out a small section from a microscopic sample 102—for example, from a thin tissue or organ section. The sample 102 is connected in particular by a membrane 304 to a sample carrier 300, which makes it possible to handle in particular thin samples without damaging them. A sample carrier 300 by way of example is described below with reference to FIG. 3. In the context of microdissection, the section that is cut out is also called dissectate 104. In the laser microdissection system 100 shown, the cut-out dissectate 104 is collected by utilizing gravity in a collecting vessel 106 which is arranged below the sample 102 in a collecting unit 108. Such an arrangement is also called a Laser Capture Microdissection (LCM) system.

In the exemplary embodiment shown in FIG. 1, the collecting unit 108 is, purely by way of example, a multiwell plate having a plurality of wells, each of which forms a collecting vessel 106. Alternatively, the collecting vessel 106 may also be a PCR tube or a cap of a PCR tube, which may be arranged in a frame having a plurality of additional PCR tubes. The collecting unit 108 and/or individual collecting vessels 106 can be removable in order to be able to further process the dissectate 104 outside the laser microdissection system 100.

The collecting unit 108 is arranged on a microscope stage 110 of the laser microdissection system 100. In the present exemplary embodiment, the microscope stage 110 is movable in order to position the collecting unit 108 and the sample 102 relative to the body of the laser microdissection system 100. In particular, the microscope stage 110 is movable along an optical axis O of the laser microdissection system 100, i.e., in the z-direction. This is shown in FIG. 1 by a double arrow P. As a result, the collecting unit 108 can be moved vertically—for example, in order to move a focus position FP within the collecting vessel 106. However, the microscope stage 110 can also be immovable in the z-direction.

The laser microdissection system 100 comprises, purely by way of example, a nosepiece 112 on which lenses 114 are arranged. The lenses 114 arranged on the nosepiece 112 can be alternately pivoted into the optical axis O of the laser microdissection system 100. This allows a user to select a suitable lens 114 for different tasks, e.g., for cutting the sample 102, for observing the sample 102 or the dissectate 104 in the collecting vessel 106, or for inspecting the collecting vessel 106. In the exemplary embodiment shown, the nosepiece 112 is immovable with respect to the housing of the laser microdissection system 100. In another exemplary embodiment, the nosepiece 112 can also be movable along the optical axis O of the laser microdissection system 100, i.e., in the z-direction, so that the focus position FP of the currently selected lens 114 can be displaced with respect to the sample 102, the dissectate 104, and/or the collecting vessel 106. Instead of a nosepiece 112, the laser microdissection system 100 may also have a single lens holder to which interchangeable lenses 114 can be attached. The lens holder can be movable in particular along the optical axis O of the laser microdissection system 100, in order to be able to shift the focus position FP of the currently attached lens 114.

The laser microdissection system 100 also includes a laser light source 116 and a deflection unit 118, which together form a cutting unit 120 of the laser microdissection system 100. The laser light source 116 is configured to generate laser light 122 for cutting the sample 102. The generated laser light 122 is directed by the deflection unit 118 and a first beam splitter 124 into the lens 114, which is currently pivoted into the optical axis O of the laser microdissection system 100, and is directed onto the sample 102. The deflection unit 118 is configured to move a target point of the laser light 122 on the sample 102 for cutting the sample 102. In an alternative exemplary embodiment, the laser microdissection system 100 does not include a deflection unit 118, while the microscope stage 110 is movable perpendicularly to the optical axis O, so that the target point on the sample 102 can be moved with the aid of the microscope stage 110.

An illumination unit 126 of the laser microdissection system 100 is designed to generate illumination light 128 for illuminating an object—for example, the sample 102, the dissectate 104, and/or the collecting vessel 106. For example, the illumination unit 126 includes an excitation light source, such as another laser light source, for generating excitation light that excites fluorophores to emit fluorescent light. However, the illumination unit 126 can also comprise a white light source for illuminating the object with white light for front lighting or transmitted-light illumination. Purely by way of example, the illumination unit 126 shown is designed to generate a beam from the illumination light 128, which is directed by a second beam splitter 130 into the lens 114, which is currently pivoted into the optical axis O of the laser microdissection system 100, and is directed onto the object to be illuminated.

An optical detection unit 132 of the laser microdissection system 100 comprises, purely by way of example, the lens 114 currently pivoted into the optical axis O of the laser microdissection system 100, the first beam splitter 124, the second beam splitter 130, and a detector element 134. Detection light emanating from the sample 102 or the dissectate 104, e.g., reflected illumination light 128 or the fluorescence light emanating from the sample 102 or the dissectate 104, is directed by the first beam splitter 124 and the second beam splitter 130 onto the detector element 134. The detector element 134 captures the detection light in order to generate an image of the sample 102 or the dissectate 104. The detector element 134 further generates image data corresponding to the image. The optical detection unit 132 can in particular be designed to capture fluorescence images.

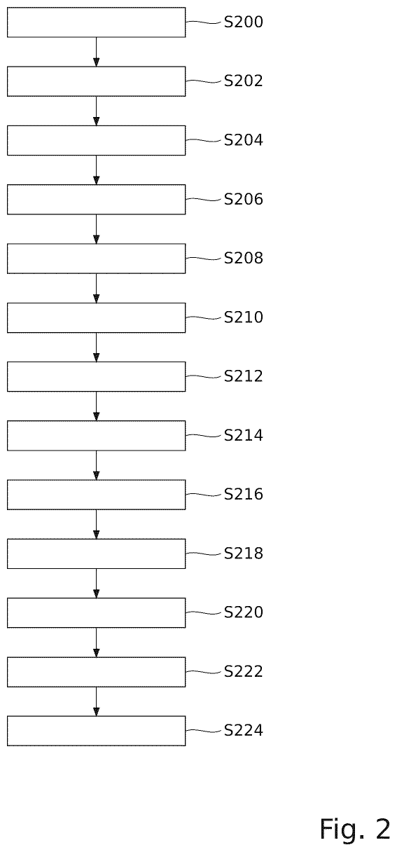

The laser microdissection system 100 further comprises a control unit 136 which is connected to the microscope stage 110, the nosepiece 112, the cutting unit 120, the illumination unit 126, and the optical detection unit 132, and is designed to control the aforementioned elements. The control unit 136 comprises, by way of example, a user input unit 138 which is designed to receive user inputs from the user. Furthermore, the control unit 136 is designed to control the laser microdissection system 100 for carrying out a laser microdissection method. The method is described below with reference to FIG. 2.

FIG. 2 is a flowchart of the laser microdissection method.

The method can be carried out in particular by the laser microdissection system 100 described with reference to FIG. 1. In the method, the dissectate 104 is cut from the sample 102 and collected by the collecting unit 108. It is further determined whether the dissectate 104 was correctly collected in the collecting vessel 106. The method is started in step S200.

In the optional step S202, the collecting unit 108 is introduced into the laser microdissection system 100 and arranged on the microscope stage 110. This can be done manually by the user or by a robot arm designed for handling the collecting unit 108. The robot arm can be controlled by the control unit 136. The collecting unit 108 can also be part of the microscope stage 110. In such an embodiment of the laser microdissection system 100, individual collecting vessels 106 can be arranged in the collecting unit 108 in step S202—for example, manually by the user or automatically by the robot arm. In an alternative embodiment of the method, the collecting unit 108 and the collecting vessels 106 are already arranged when the method is started in step S200.

In the likewise optional step S204, the control unit 136 controls the optical detection unit 132 for capturing a before image of an interior of one of the collecting vessels 106 of the collecting unit 108, in which the dissectate 104 is to be collected. The optical detection unit 132 generates before image data corresponding to the before image. The before image data can be used in the further course of the method to compare images and thereby determine whether the dissectate 104 was correctly collected in the collecting vessel 106.

In step S206, the sample 102 is placed above the collecting vessel 106 so that the dissectate 104 cut from the sample 102 can be collected in the collecting vessel 106. The sample 102 can in particular be arranged manually by the user. Alternatively, the sample 102 can also be arranged by the robot arm above the at least one collecting vessel 106. In the optional step S208, the control unit 136 controls the optical detection unit 132 for capturing a first image of the sample 102. The detection unit 132 generates first sample image data corresponding to the first image of the sample 102. For example, based upon the first image of the sample 102, the user may, in the following step S210, select an ROI to be cut by the laser microdissection system 100. A first image of the sample 102, by way of example, is described below with reference to FIG. 3.

In step S210, the region of the sample 102 to be cut out is selected. This can be done fully automatically by the control unit 136 based upon the first sample image data. For example, the control unit 136 determines the positions of certain structures of the sample 102, e.g., a certain type of cells, based upon the first sample image data. Alternatively, the region of the sample 102 to be cut out can be determined by the user, in particular by a user input. In the following step S212, the control unit 136 then controls the cutting unit 120 to cut out the region to be cut out to produce the dissectate 104.

In the optional step S214, the control unit 136 controls the optical detection unit 132 for capturing a second image of the sample 102. The detection unit 132 generates second sample image data corresponding to the second image of the sample 102. Based upon the second sample image data, the control unit 136 can in particular determine a size of the dissectate 104, e.g., a length, a width, a diameter, and/or a surface area of the dissectate 104, by equating the size of the dissectate 104 with a corresponding size of the cut-out region. The size of the dissectate 104 can also be determined based upon a corresponding size of the ROI—for example, based upon the first image data. Furthermore, the user can also enter the size of the dissectate 104 as a user input.

In step S216, the control unit 136 controls the optical detection unit 132 for capturing a content image of the interior of the collecting vessel 106. The optical detection unit 132 generates content image data corresponding to the content image. The content image can be captured as a fluorescence image. Thus, the dissectate 104 can be easily identified by the fluorescent light emanating from the dissectate 104, which may, for example, be emitted by fluorophores introduced into the sample 102 or generated by autofluorescence. In particular, the membrane 304 on which the sample 102 is applied may exhibit autofluorescence. In particular, the control unit 136 controls the optical detection unit 132 for capturing the content image such that it is captured as a volume image or an image with extended depth of field. In both cases, the content image corresponds to an expanded volume in the interior of the collecting vessel 106. It can thus also be determined whether the dissectate 104 adheres to a wall of the collecting vessel 106. In order to be able to capture a volume image or an image with extended depth of field, the control unit 136 can in particular also control the microscope stage 110 in order to move it in the z-direction.

Then, in step S218, the control unit 136 determines, based upon the content image data, whether the dissectate 104 is located in the collecting vessel 106. If the size of the dissectate 104 was determined, e.g., in step S216, the control unit 136 can take the size into account in the determination. In a first method by way of example, the control unit 136 compares the content image with the before image acquired in step S204 in order to determine whether the dissectate 104 was collected in the collecting vessel 106. Alternatively or in addition to the before image, the control unit 136 can also compare the content image with at least one reference image, which is an image of an interior of a collecting vessel 106 of the same type as the collecting vessel 106 in which the dissectate 104 is to be collected. For example, an image of a well of a microwell plate that has the same dimensions as the well used to collect the dissectate 104. In order to compare the images, the control unit 136 processes the content image data as well as the before image data and/or reference image data corresponding to the reference image using an image comparison method, in particular a machine learning method. In another method by way of example, the control unit 136 uses a machine learning method that has been trained at least on the basis of the reference image data, in order to determine whether the dissectate 104 was collected in the collecting vessel 106. For example, the machine learning method may be an image segmentation method, in particular a semantic segmentation method, which segments the content image in order to identify the dissectate 104.

In the optional step S220, the control unit 136 determines a position of the dissectate 104 in the collecting vessel 106 based upon the content image data. This makes it possible to find the dissectate 104 in the collecting vessel 106 in order, for example, to capture a detailed image of the dissectate 104. In the further optional step S222, the control unit 136 controls the optical detection unit 132 for capturing a verification image of the interior of the collecting vessel 106. The optical detection unit 132 generates verification image data corresponding to the verification image. In particular, the verification image is a detailed image of the interior of the collecting vessel 106 at the position of the dissectate 104 determined in step S220. Alternatively or additionally, the verification image may be a fluorescence image, so that the dissectate 104 can be identified using fluorescent light. Based upon the verification image, it can be confirmed that the dissectate 104 was collected correctly.

The method is terminated in step S224.

FIG. 3 is a schematic illustration of the sample carrier 300 on which the sample 102 is arranged.

The sample carrier 300 shown in FIG. 3 has, purely by way of example, the dimensions of a microscope slide, as is commonly used in microscopy. This makes the sample carrier 300 compatible with other laboratory equipment, such as a microscope or a slide scanner. The sample carrier 300 has a frame 302 with a recess, over which the membrane 304 is stretched, on which the sample 102 is applied, and which can be cut with the aid of the laser light 122. The membrane 304 is, for example, made of polyethylene naphthalate, which exhibits fluorescence in visible light. As an alternative variant of the sample carrier, a glass slide without an opening can also be used, over which a laser-cuttable film is stretched, which is fixed only in the edge region of the glass slide—for example, by gluing.

FIG. 3 also has a section 306 represented by a dashed square, which corresponds to the before image. The ROI 308, i.e., the region of the sample 102 that is to be cut out in order to obtain the dissectate 102, is located within this section 306. The ROI 308 is, purely by way of example, circular and represented by a dashed circle.

The term “and/or” can be abbreviated as “/” and includes all combinations of one or more of the associated listed items.

Although some aspects have been described in the context of a device, it is clear that such aspects also constitute a description of the corresponding method, a block or a device corresponding to a method step, or a function of a method step. Similarly, aspects described in the context of a method step also constitute a description of a corresponding block or element, or a feature of a corresponding device.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 laser microdissection system
102 sample
104 dissectate
106 collecting vessel
108 collecting unit
110 microscope stage
112 nosepiece
114 lens
116 laser light source
118 deflection unit
120 cutting unit
122 laser light
124 beam splitter
126 illumination unit
128 illumination light
130 beam splitter
132 detection unit
134 detector element
136 control unit
138 user input unit
300 sample carrier
302 frame
304 membrane
306 section
308 ROI

1. A laser microdissection system, comprising:
a microscope stage configured to receive a sample to be cut and a collecting unit comprising at least one collecting vessel arranged below the sample, wherein the at least one collecting vessel is arranged and configured to collect a dissectate cut out of the sample;
an optical detection unit configured to capture a content image of an interior of the at least one collecting vessel and to generate content image data corresponding to the content image; and
a control unit configured to process the content image data and to determine whether the dissectate is located in the at least one collecting vessel based on the content image data and taking into account previous image data corresponding to a previous image of the interior of the at least one collecting vessel that was taken before the dissectate was cut from the sample, and/or taking into account reference image data corresponding to a reference image of an interior of a reference collecting vessel of a same type as the at least one collecting vessel.

2. The laser microdissection system according to claim 1, wherein the control unit is configured to determine a position of the dissectate in the interior of the at least one collecting vessel based on the content image data.

3. The laser microdissection system according to claim 1, wherein the control unit is configured to compare the content image data with the previous image data and/or the reference image data, and to determine on the basis of this comparison whether the dissectate is located in the at least one collecting vessel.

4. The laser microdissection system according to claim 1, wherein the control unit is configured to determine, using a machine learning method, whether the dissectate is located in the at least one collecting vessel.

5. The laser microdissection system according to claim 4, wherein the machine learning model is trained, using at least the reference image data as training data, to determine whether the dissectate is located in the at least one collecting vessel.

6. The laser microdissection system according to claim 4, wherein the machine learning model is trained to perform image segmentation of the content image in order to determine whether the dissectate is located in the at least one collecting vessel.

7. The laser microdissection system according to claim 1, wherein the control unit is configured to control at least the optical detection unit in order to capture the content image as a volume image and/or an image with extended depth of field.

8. The laser microdissection system according to claim 7, wherein the microscope stage is movable in a motorized manner along an optical axis of the optical detection unit, and wherein the control unit is configured to move the microscope stage along the optical axis of the optical detection unit in order to capture the content image as the volume image and/or the image with extended depth of field.

9. The laser microdissection system according to claim 1, wherein the control unit is configured to determine, taking into account a size of the dissectate, whether the dissectate is located in the at least one collecting vessel.

10. The laser microdissection system according to claim 9, further comprising a user input unit configured to receive a user input, wherein the control unit is configured to determine the size of the dissectate based on the user input.

11. The laser microdissection system according to claim 9, wherein the control unit is configured to determine the size of the dissectate based on sample image data corresponding to an image of the sample acquired before or after the dissectate is cut from the sample.

12. The laser microdissection system according to claim 1, further comprising an illumination unit configured to emit excitation light for exciting fluorophores, wherein the optical detection unit is configured to capture fluorescence images.

13. The laser microdissection system according to claim 12, wherein the control unit is configured to control the illumination unit and the optical detection unit in order to capture the content image as a respective fluorescence image.

14. The laser microdissection system according to claim 12, wherein the control unit is configured to control the illumination unit and the optical detection unit in order to capture a verification image as a respective fluorescence image upon determining that the dissectate is located in the at least one collecting vessel, to generate verification image data corresponding to the verification image, and to confirm, based on the verification image data, that the dissectate is located in the at least one collecting vessel.

15. A laser microdissection method comprising:
arranging a sample above at least one collecting vessel of a collecting unit, wherein the at least one collecting vessel is arranged and configured to collect a dissectate cut from the sample;
capturing a content image of an interior of the at least one collecting vessel, and generating content image data corresponding to the content image; and
based on the content image data and taking into account previous image data corresponding to a previous image of the interior of the at least one collecting vessel that was taken before the dissectate was cut from the sample, and/or taking into account reference image data corresponding to a reference image of an interior of a reference collecting vessel of a same type as the at least one collecting vessel, determining whether the dissectate is located in the at least one collecting vessel.
